(19) United States
(12) Patent Application Publication
(10) Pub. No.: US 2010/0137116 A1
(43) Pub. Date: Jun. 3, 2010

(54) QUICK-POSITIONING SCREW ASSEMBLY MACHINING METHOD

(75) Inventor: Ming-Chung Chiu, Keelung City (TW)

Correspondence Address: HANWIT PRECISION INDUSTRIES LTD., P.O.BOX 108-00403, TAIPEI, 106, omitted

(73) Assignee: HANWIT PRECISION INDUSTRIES LTD., Sijhih City (TW)

(21) Appl. No.: 12/326,892

(22) Filed: Dec. 3, 2008

(51) Int. Cl. B23Q 1/25; B23P 11/00

(52) U.S. Cl. 483/17; 29/281.5

(57) ABSTRACT

A quick-positioning screw assembly machining method includes the step of attaching a quick-positioning screw assembly to a chucking device of a machine tool and then driving the chucking device to rotate the quick-positioning screw assembly, the step of moving a ramming member toward a relatively thinner front extension cap wall of a cap during rotation of the quick-positioning screw assembly to have the relatively thinner front extension cap wall of the cap be bent radially inwards into contact with a periphery of a mounting socket between two outside annular flanges of the mounting socket, and the step of stopping the rotation of the chucking device and removing the processed quick-positioning screw assembly from the machine tool.

### BACKGROUND OF THE INVENTION

1. Field of the Invention

The present invention relates to a quick positioning screw assembly for quick installation to fasten two plate members together and more particularly, to a quick-positioning screw assembly machining method for processing the relatively thinner front extension cap wall of the cap of the quick-positioning screw assembly into coupled with the mounting socket of the quick-positioning screw assembly.

2. Description of the Related Art

Fastening plate members in a stack is an application of stacking attachment technique to fully utilize the space. With respect to the functioning of the power drive or speed-adjustment unit of a machine tool, when the machine base failed or an adjustment of the speed of the machine is necessary, a movable plate member will be detachably mounted on the housing of the power drive or speed-adjustment unit. Screw bolts are commonly used to secure a movable plate member to a machine tool. When unfastening screw bolts to dismount a movable plate member from a machine tool, the associating lock nuts may fall from the screw bolts.

FIGS. 7 and 8 show a positioning screw assembly for securing two plate members together. As illustrated, the positioning screw assembly is comprised of a cap A, a screw A2, a spring member A3 and a mounting socket B. The screw A2 is affixed to a through hole A0 of the cap A for rotation with the cap A. The spring member A3 is sleeved onto the screw A2 and received inside the cap A. The mounting socket B is mounted in the cap A to hold the spring member A3 around the screw A2. To avoid disconnection of the mounting socket B from the cap A, a pressure tube C is used to deform a front extension cap wall A1 of the cap A, forcing the front extension cap wall A1 radially inwards toward a periphery B1 of the mounting socket B between two outside annular flanges, i.e., a top stop flange B2 and a bottom mounting flange B3 of the mounting socket B.

The aforesaid method of using the pressure tube C to process the front extension cap wall A1 of the cap A has drawbacks as follows:
1. The diameter of a pressure face C1 in an inner diameter C0 of the pressure tube C is greater than the outer diameter of the bottom mounting flange B3 of the mounting socket B. After processing to have the front extension cap wall A1 of the cap A be bend radially inwards, a gap D is left between the deformed front extension cap wall A1 of the cap A and the periphery B1 of the mounting socket B. When rotating the cap A to thread the screw A2 into a screw hole on a plate member, the deformed front extension cap wall A1 of the cap A is not kept into contact with the periphery B1 of the mounting socket B to guide movement of the cap A relative to the mounting socket B, resulting in vibration of the cap A relative to the mounting socket B. Thus, the outer threads of the screw A2 may be forced against the inner threads of the screw hole of the plate member, causing damage. In case of damage of the threads, the plate members may be forced to fall from each other during delivery.
2. The quick-positioning screw assembly has no retaining means between the through hole A0 of the cap A and the top stop flange B2 of the mounting socket B. When processing the front extension cap wall A1 of the cap A with the pressure tube C, the spring force of the spring member A3 may force the cap A out of the pressure tube C, complicating the processing process.

### SUMMARY OF THE INVENTION

The present invention has been accomplished under the circumstances in view. It is therefore the main object of the present invention to provide a quick-positioning screw assembly machining process, which uses a machine tool to process a relatively thinner front extension cap wall of a cap accurately and rapidly into contact with a periphery of a mounting socket so that the processed quick-positioning screw assembly can be quickly and stably fastened to plate members to secure the plate members firmly together.

According to one aspect of the present invention, the quick-positioning screw assembly machining method uses a chucking device of a machine tool to hold and rotate the quick-positioning screw assembly, and a ramming member to ram the relatively thinner front extension cap wall of the cap during rotation of the quick-positioning screw assembly, and therefore the relatively thinner front extension cap wall of the cap is bent radially inwards into contact with the periphery of the mounting socket between the two outside annular flanges of the mounting socket. Because the processed relatively thinner front extension cap wall of the cap is kept into contact with the periphery of the mounting socket, the screw can be moved with the cap relative to the mounting socket stably when the screw is driven into the plate members.

According to another aspect of the present invention, the cap comprises an inside annular flange adapted to support the screw, a locating groove extending around the inside wall thereof at the bottom side of the inside annular flange, and a retaining ring mounted in the locating groove for securing the top outside annular flange of the mounting socket. Therefore, the cap and the mounting socket are kept together during the process of processing the relatively thinner front extension cap wall of the cap. After the processing process, the cap can be pulled relative to the mounting socket to disconnect the engagement between the retaining ring and the top outside annular flange of the mounting socket for allowing the screw be moved with the cap relative to the mounting socket.

### BRIEF DESCRIPTION OF THE DRAWINGS

FIG. 1 is an operation flow chart of a quick-positioning screw assembly machining method according to the present invention.

FIG. 2 is a schematic front view, showing a quick-positioning screw assembly attached to a chucking device of a machine tool according to the present invention.

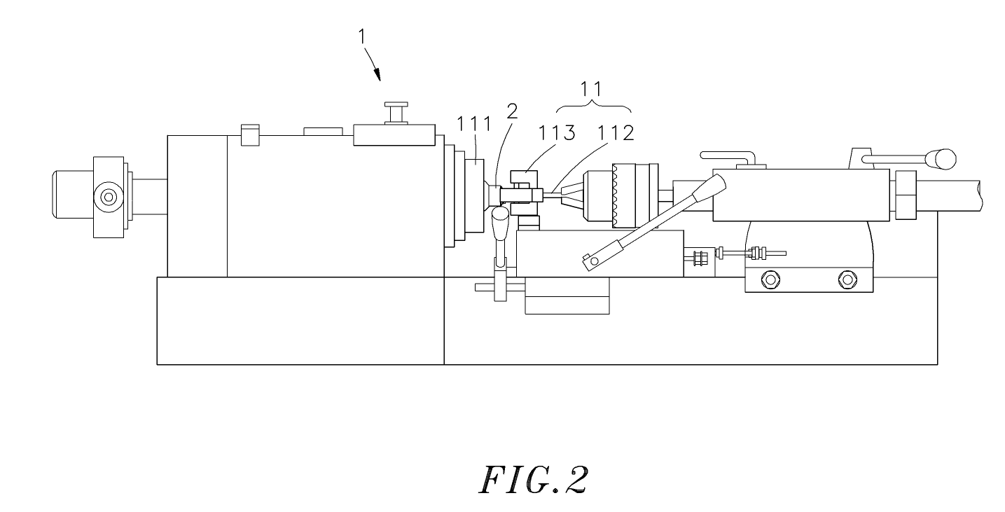

FIG. 3 is top view of FIG. 2.

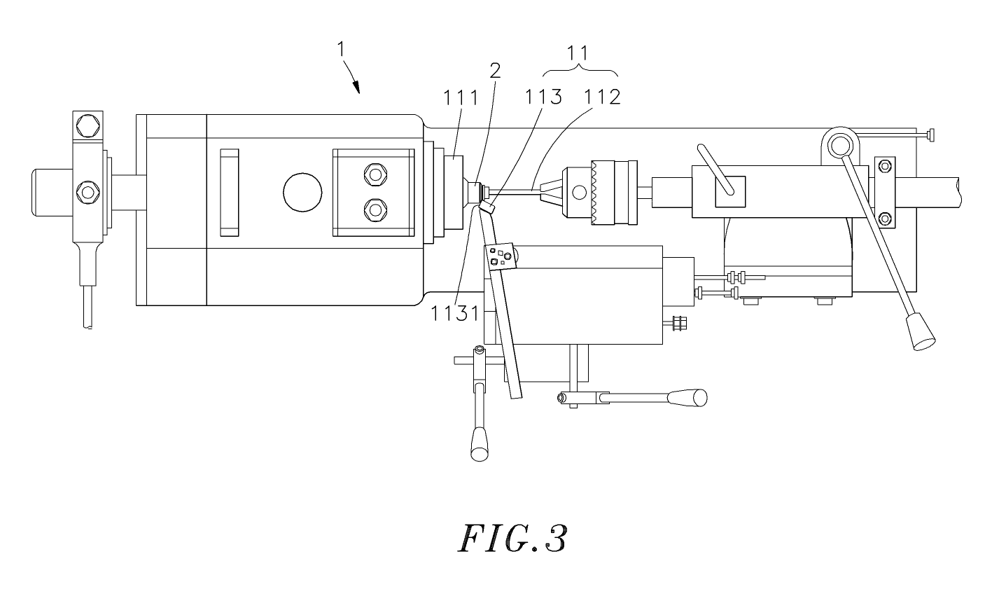

FIG. 4 is a sectional view of a part of the present invention, showing the ramming member of the machine tool forced against the relatively thinner front extension cap wall of the cap of the quick-positioning screw assembly and the relatively thinner front extension cap wall of the cap bent radially inwards.

FIG. 5 is an exploded view of the quick-positioning screw assembly in accordance with the present invention before processing.

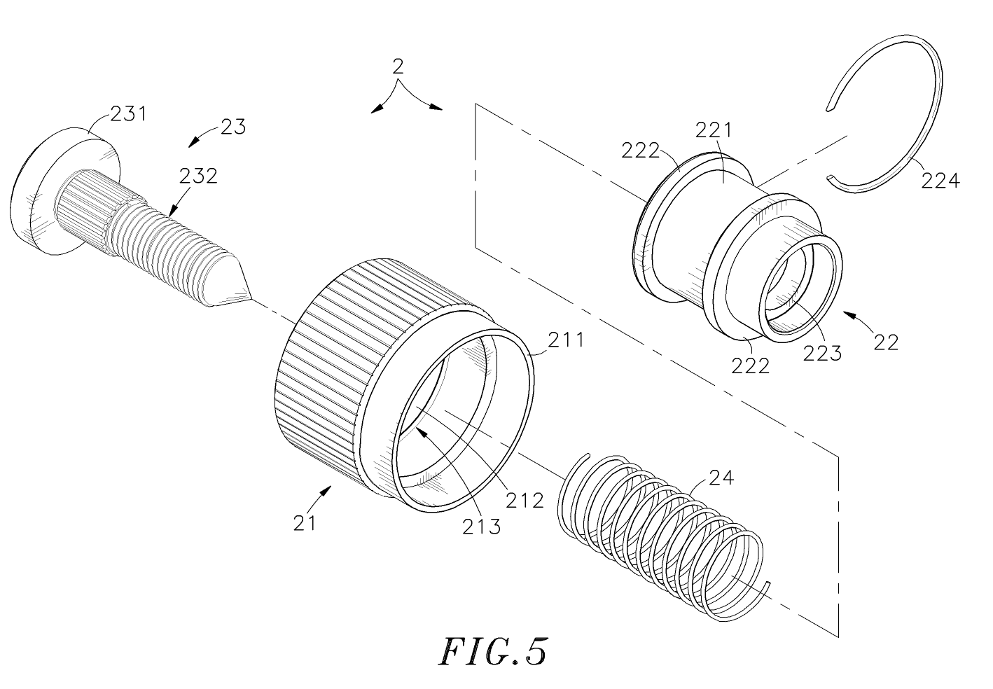

FIG. 6 is an elevational view showing the structure of the quick-positioning screw assembly after the machining process.

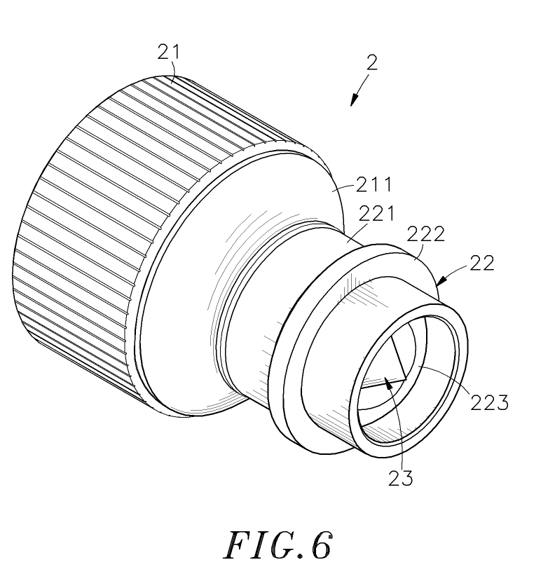

FIG. 7 is a schematic sectional view showing the machining process of a quick-positioning screw assembly according to the prior art.

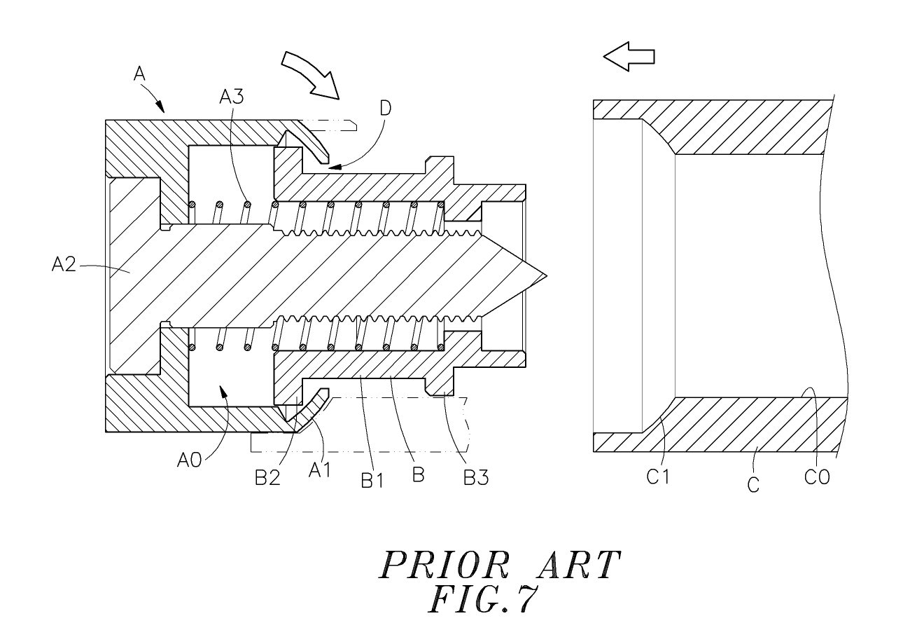

FIG. 8 is an elevational view showing the structure of the quick-positioning screw assembly after the machining process according to the prior art.

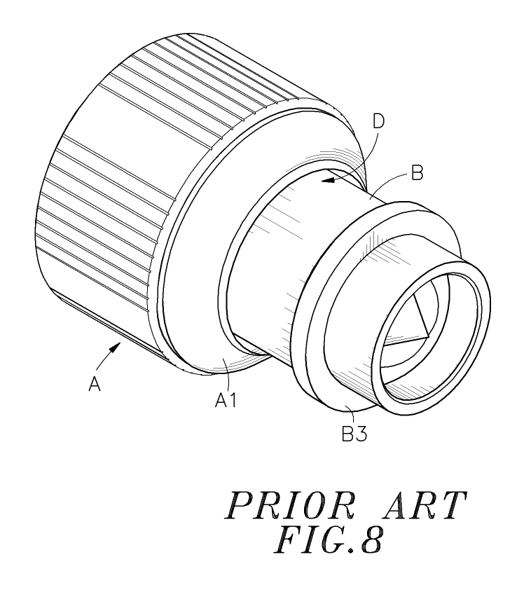

### DETAILED DESCRIPTION OF THE PREFERRED EMBODIMENT

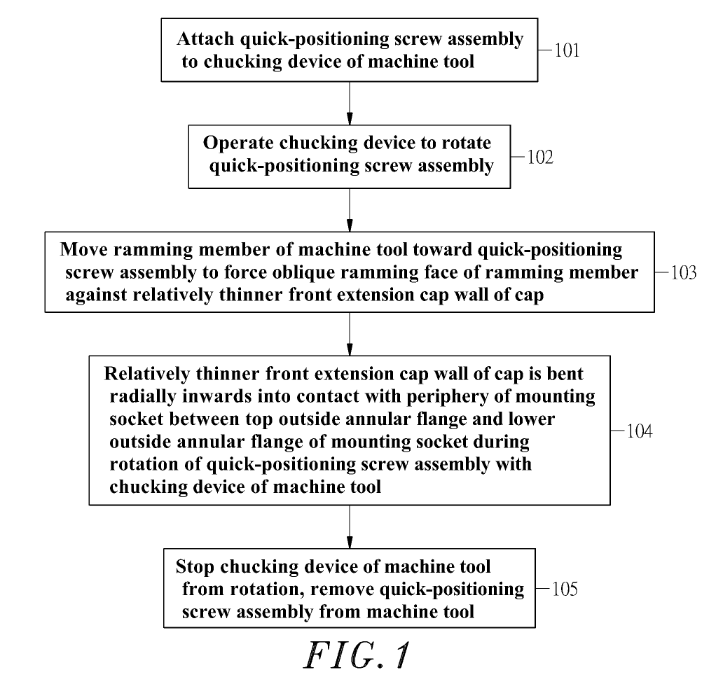

Referring to FIGS. 1˜6, a quick-positioning screw assembly 2 is shown comprising cap 21, a mounting socket 22 mounted in the cap 21 for fastening to a mounting through hole of a first plate member (not shown), a screw 23 mounted in the cap 21 for threading into a screw hole on a second plate member (not shown) to secure the first plate member to the second plate member, and an elastic member 24 mounted in the cap 21 around the screw 23 and stopped between the cap 21 and the mounting socket 22. The method of the present invention is to use a machine tool 1 to process the cap 21 of the quick-positioning screw assembly 2, bending a relatively thinner front extension cap wall 211 radially inwards into connection with the mounting socket 22 in such a manner that the cap 21 and the mounting socket 22 are coupled together and can be moved axially relative to each other within a limited range. Before the processing, the mounting socket 22 is inserted into the inside of the cap 21 to have the relatively thinner front extension cap wall 211 be extended over a periphery 221 between two outside annular flanges 222. The quick-positioning screw assembly machining method includes the steps of:
(101) attaching the quick-positioning screw assembly 2 to a chucking device 11 of the machine tool 1 to have the cap 21 and the mounting socket 22 of the quick-positioning screw assembly 2 be respectively secured to a female chucking member 111 and a male chucking member 112 of the chucking device 11;
(102) rotating the female chucking member 111 and the male chucking member 112 of the chucking device 11 to have the quick-positioning screw assembly 2 be synchronously rotated with the chucking device 11 of the machine tool 1;
(103) moving a ramming member 113 of the machine tool 1 toward the quick-positioning screw assembly 2 to force an oblique ramming face 1131 of the ramming member 113 against the relatively thinner front extension cap wall 211 of the cap 21;
(104) the relatively thinner front extension cap wall 211 of the cap 21 is bent radially inwards into contact with the periphery 221 of the mounting socket 22 during rotation of the quick-positioning screw assembly 2 with the chucking device 11 of the machine tool 1; and
(105) stopping the rotation of the chucking device 11 of the machine tool 1; and then removing the quick-positioning screw assembly 2 from the machine tool 1.

As stated above, the invention uses the female chucking member 111 and the male chucking member 112 of the chucking device 11 of the machine tool 1 to hold the quick-positioning screw assembly 2 and to rotate it, and the ramming member 113 to ram the relatively thinner front extension cap wall 211 of the cap 21 during rotation of the quick-positioning screw assembly 2 with the chucking device 11 of the machine tool 1. Therefore, the relatively thinner front extension cap wall 211 of the cap 21 is bent radially inwards into contact with the periphery 221 of the mounting socket 22 between the two outside annular flanges 222. After the processing process, the mounting socket 22 and the cap 21 are coupled together to hold the elastic member 24 and the screw 23 on the inside, and the screw 23 can be rotated with the cap 21 and moved axially with the cap 21 relative to the mounting socket 22.

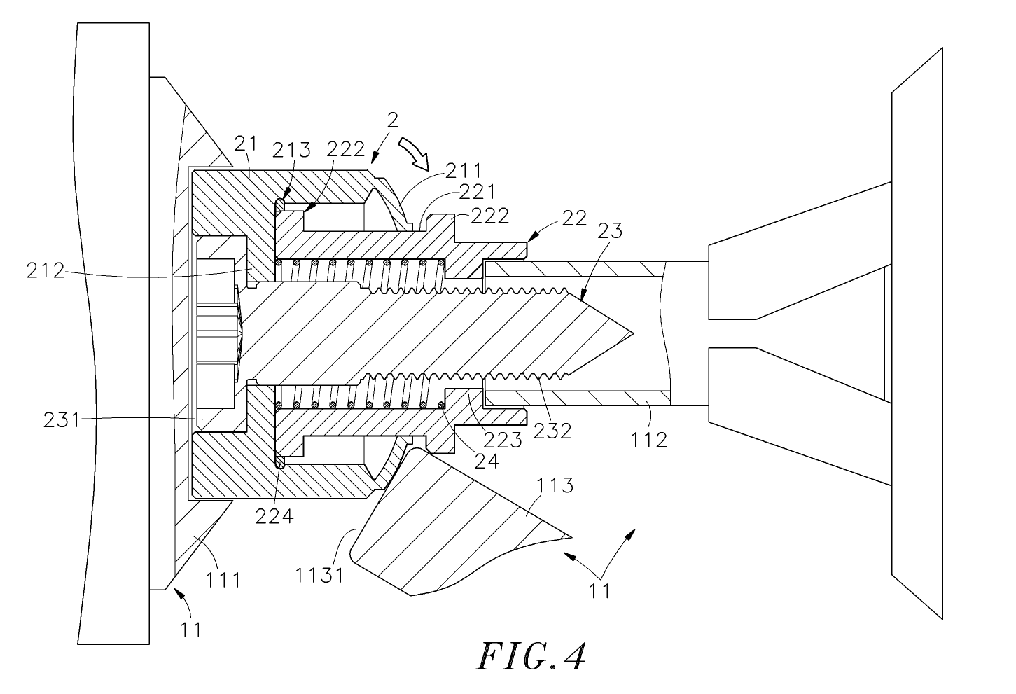

Referring to FIGS. 4˜6 again, the screw 23 has a head 231 supported on an inside annular flange 212 of the cap 21, and a threaded shank 232 axially extending from the bottom side of the head 231 to the outside of the cap 21. The screw 23 is fixedly secured to the inside of the cap 21 for rotation with the cap 21. The elastic member 24 can be, for example, a coil spring sleeved onto the threaded shank 232 of the screw 23 and stopped between the inside annular flange 212 of the cap 21 and an inside annular flange 223 of the mounting socket 22. Further, a C-shaped retaining ring 224 is mounted in a locating groove 213 inside the cap 21 to temporarily secure the upper outside annular flange 222 of the mounting socket 22 to the bottom side of the inside annular flange 212 of the cap 21.

During installation the quick-positioning screw assembly 2, insert the mounting socket 22 into a mounting through hole of a first plate member (not shown) to have the lower outside annular flange 222 of the mounting socket 22 be stopped at a solder paste on the top wall of the first plate member around the mounting through hole and then soldered to the first plate member by the solder paste by means of a soldering process. Thereafter, pull the cap 21 outwards with the hand to disengage the C-shaped retaining ring 224 from the upper outside annular flange 222 of the mounting socket 22 for allowing the cap 21 and the screw 23 be moved axially relative to the mounting socket 22, and then the screw 23 is forced with the cap 21 downwards and then rotated with the cap 21 and to thread the threaded shank 232 into a corresponding screw hole on a second plate member (not shown) to affix the second plate member and the first plate member together.

In general, the invention uses the female chucking member 111 and the male chucking member 112 of the chucking device 11 of the machine tool 1 to hold the quick-positioning screw assembly 2 and to rotate it, and the ramming member 113 to ram the relatively thinner front extension cap wall 211 of the cap 21 during rotation of the quick-positioning screw assembly 2 with the chucking device 11. Therefore, the relatively thinner front extension cap wall 211 of the cap 21 is bent radially inwards into contact with the periphery 221 of the mounting socket 22 between the two outside annular flanges 222 to secure the mounting socket 22 to the cap 21, allowing axial movement of the cap 21 relative to the mounting socket 22.

In conclusion, the quick-positioning screw assembly machining method of the present invention has the following features and advantages:

1. The invention uses the chucking device 11 of the machine tool 1 to hold and rotate the quick-positioning screw assembly 2, and the ramming member 113 of the machine tool 1 to ram the relatively thinner front extension cap wall 211 of the cap 21, and therefore the relatively thinner front extension cap wall 211 of the cap 21 is bent radially inwards into contact with the periphery 221 of the mounting socket 22 between the two outside annular flanges 222. After the processing process, the mounting socket 22 and the cap 21 are coupled together to hold the elastic member 24 and the screw 23 on the inside, and the screw 23 can be rotated with the cap 21 and moved axially with the cap 21 relative to the mounting socket 22.

2. The design of the outside annular flanges 222 of the mounting socket 22 enables the mounting socket 22 to be quickly and accurately bonded to a mounting through hole of a first plate member by means of an automatic mounting system.

3. The cap 21 has a locating groove 213 on the inside for the mounting of a C-shaped retaining ring 224 to secure the upper outside annular flange 222 of the mounting socket 22 to the bottom side of the inside annular flange 212 of the cap 21 so that the quick-positioning screw assembly 2 can be installed in plate members to fasten the plate members together by means of an automatic mounting system.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A quick-positioning screw assembly machining process adapted for processing a quick-positioning screw assembly, said quick-positioning screw assembly comprising a cap, said cap comprising a relatively thinner front extension cap wall, a mounting socket mounted in said cap for fastening to a mounting through hole of a first plate member, said mounting socket comprising a top outside annular flange and a lower outside annular flange respectively extending around a periphery thereof at different elevations, a screw mounted in said cap and rotatable with said cap for threading into a screw hole on a second plate member to secure said first plate member to said second plate member, and an elastic member mounted in said cap around said screw and stopped between said cap and said mounting socket, the quick-positioning screw assembly machining process comprising the steps of:
(a) attaching said quick-positioning screw assembly to a chucking device of a machine tool;
(b) operating said chucking device to rotate said quick-positioning screw assembly;
(c) moving a ramming member of said machine tool toward said quick-positioning screw assembly to force a oblique ramming face of said ramming member against said relatively thinner front extension cap wall of said cap;
(d) said relatively thinner front extension cap wall of said cap being bent radially inwards into contact with said periphery of said mounting socket between said top outside annular flange and said lower outside annular flange of said mounting socket during rotation of said quick-positioning screw assembly with said chucking device of said machine tool; and
(e) stopping the rotation of said chucking device of said machine tool, and then removing said quick-positioning screw assembly from said machine tool.

2. The quick-positioning screw assembly machining process as claimed in claim 1, wherein said chucking device comprises a female chucking member and a male chucking member of said chucking device disposed opposite to each other for holding said cap and said mounting socket of said quick-positioning screw assembly be respectively.

3. The quick-positioning screw assembly machining process as claimed in claim 1, wherein said cap comprises an inside annular flange adapted to support said screw, a locating groove extending around an inside wall thereof at a bottom side of said inside annular flange, and a retaining ring mounted in said locating groove for securing said top outside annular flange of said mounting socket.

4. The quick-positioning screw assembly machining process as claimed in claim 3, wherein said screw is forced into friction engagement with an inner diameter of said inside annular flange of said cap, comprising a head supported on said inside annular flange of said cap and a threaded shank extending out of said cap and inserted into said mounting socket.

5. The quick-positioning screw assembly as claimed in claim 1, said mounting socket comprises an inside annular flange adapted to support said elastic member.
